(19) United States
(12) Patent Application Publication
(10) Pub. No.: US 2008/0313202 A1
(43) Pub. Date: Dec. 18, 2008

(54) Method and apparatus for semantic keyword clusters generation

(76) Inventor: Yakov Kamen, Cupertino, CA (US)

Correspondence Address: Yakov Kamen, 19334 Greenwood Drive, Cupertino, CA, 95014, US

(21) Appl. No.: 11/811,657

(22) Filed: Jun. 12, 2007

(51) Int. Cl. G06F 17/30

(52) U.S. Cl. 707/101; 707/E17.108

(57) ABSTRACT

A method and apparatus in accordance with the invention which, for any given keyword, generate a semantic keyword cluster of meanings and associated proximity scores.

### CROSS-REFERENCE TO RELATED APPLICATIONS

This application claims the benefit of provisional patent filed 2006 Jun. 11 by the present inventor

### FEDERALLY SPONSORED RESEARCH

Not applicable

### SEQUENCE LISTING OF PROGRAM

Not applicable

### BACKGROUND OF THE INVENTION

This invention pertains to technology used for data search, particularly data search over the Internet.

Search requests are usually described by keywords or search queries. Each keyword consists of single or multiple words or terms. In many applications, it would be extremely beneficial to understand how relevant (or semantically close) two different keywords are. Such knowledge could be used to define contextual advertisement bidding strategies, generate advertisement content, reconstruct people's search intentions, discover latent ties between people and documents, and more.

Successful attempts to create a method and apparatus that would numerically estimate keyword's relevance are unknown today. The problem is mathematical in nature. It may be possible to determine proximity for all single-term keywords although it would require approximately 50 billion word comparisons. Any attempt to compare all keywords of two or more terms would be virtually impossible due to the high amount of required computations. As a result, the simple question of how relevant keywords “British agent 007” and “James Bond” are to each other is still open today.

The proposed invention defines a method and apparatus to compute keywords' proximity by creation of a set of neighbor keywords (keyword clusters) using novel keyword proximity measurement technology.

### SUMMARY

The main idea of the invention is to find semantic neighbor keywords (referred herein as “meanings”, or “neighbors”) for a set of predefined “seed” keywords but not for all keywords (see FIG. 1). As a result of such operation we will create limited size cluster of semantically close keywords (called herein a “Semantic Keyword Cluster”, or “SKC”) around each seed keyword. We also propose to compute a special proximity measure (called herein a “proximity score”, “relevance”, “proximity”, or “score”) between each SKC meaning and SKC seed keyword (see FIG. 2). As a result, for every seed keyword we will generate an SKC of meanings with an assigned proximity score number for each meaning. (see FIG. 3).

In one embodiment of the invention an SKC is generated by crawling the Internet, collecting a specific set of Internet pages, extracting keywords from those pages, and computing keyword's proximity scores.

In one embodiment of the invention an SKC is generated by sending sequences of keywords to one or more Search Engines, collecting pages with search engine matches, extracting keywords from these pages, and computing keyword's proximity scores.

In one embodiment of the invention an SKC is generated by sending sequences of keywords to one or more Search Engines and one or more encyclopedia sites, collecting pages or page snippets with search engine matches and encyclopedia articles, extracting keywords from these pages and articles, and computing keyword's proximity scores.

In one embodiment of the invention a seed keyword is replaced with another keyword using a pre-defined algorithm or human interaction.

In one embodiment of the invention a seed keyword is replaced with a set of seed keywords accompanied by their relative weight coefficients. For each keyword a separate SKC is generated. The final SKC is computed as an aggregation of all seed keywords' SKCs from the above set using associated weight coefficients and other known art aggregation procedures.

In one embodiment of the invention the said set is created by at least one or a combination of the following: (i) replacing a word in the seed keyword with its plural/singular form, (ii) replacing a word in the seed keyword by stemming, (iii) replacing a word in the seed keyword with its synonym, (iv) replacing the seed keyword with a seed keyword made by permutation of words in the original seed keyword; (v) replacing the seed keyword with a seed keyword containing a subset of words in the original seed keyword.

In one embodiment of the invention the SKC and meanings proximity scores are generated using statistical analysis algorithms.

In one embodiment of the invention the statistical analysis algorithm creates a proximity score as a function of the frequency of occurrences of at least one of: a single word occurrence frequency, a word pair occurrence frequency, a word triple occurrence frequency, a word N-tuple occurrence frequency.

In one embodiment of the invention the SKC and meaning proximity scores are generated using human interactions.

In one embodiment of the invention the method and apparatus finds for a chosen seed keyword one or more different seed keywords (called “backlinks” or “reverse keywords”) that use such chosen seed keyword as their meaning in their relevant SKCs. For a backlink keyword the invention computes a backlink proximity score for the chosen keyword and aggregates backlink keywords into the chosen seed keyword's SKC as a special backlink meaning.

In one embodiment of the invention SKC size can be defined dynamically based on a relative proximity score.

In one embodiment of the invention SKC size can be defined statically and changed interactively based on SKC size criteria.

In one embodiment of the invention the SKC of a seed keyword can be extended by aggregation with at least one of the following: (i) a SKC of the seed keyword's neighbor, (ii) a SKC of the seed keyword's neighbor's neighbor, (iii) a SKC of the seed keyword's neighbor's neighbor's neighbor etc. up to arbitrary level of indirection. The above extension is called extension by transitive closure of the keyword-neighbor (meaning) relationship.

In one embodiment of the invention the SKC of a seed keyword can be extended by transitive closure of the neighbor-keyword relationship where neighbor-keyword relationship is defined as inverse relationship to the keyword-neighbor relationship.

### BRIEF DESCRIPTION OF THE DRAWINGS

FIG. 1—shows an example of SKC cluster

FIG. 2—shows an example of SKC cluster with meaning's proximity scores

FIG. 3—shows two SKC cluster in a keyword space

FIG. 4—shows a preferred embodiment system block diagram

FIG. 5—shows an embodiment system with multiple suggestions block diagram.

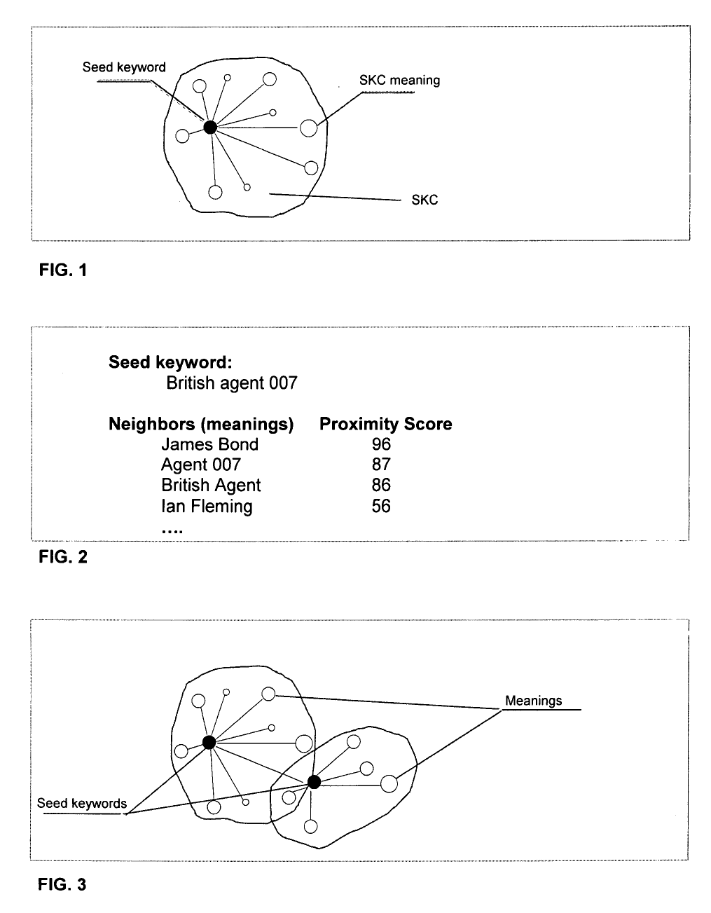

### DETAILED DESCRIPTION

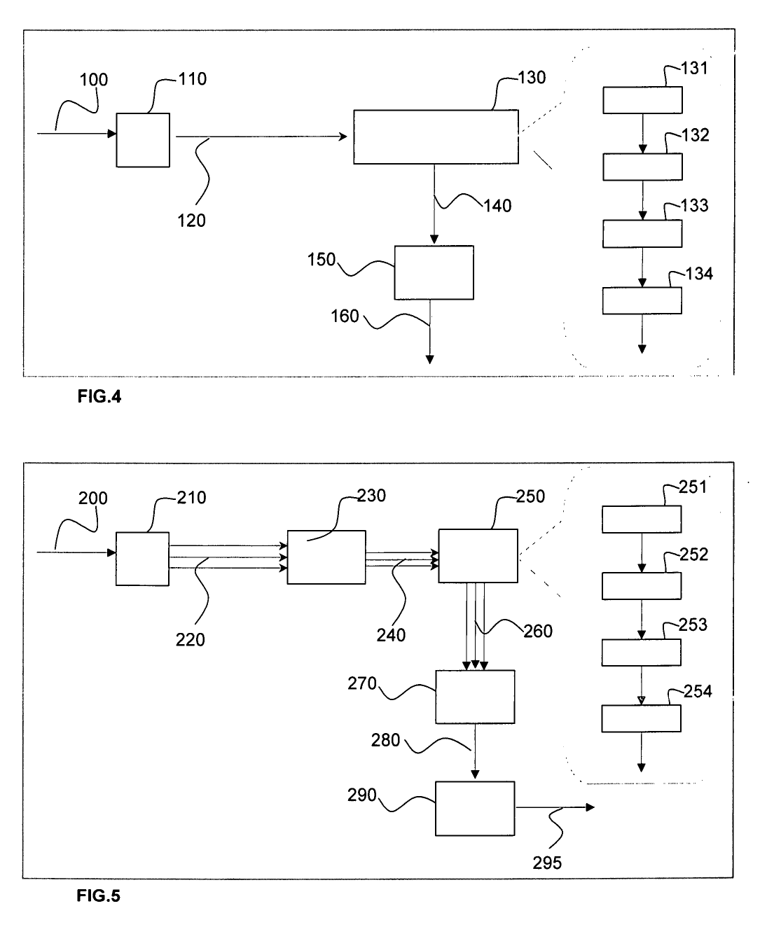

This invention is related to FIG. 4 which describes the preferred embodiment of the invention. In FIG. 4, a user is performing a search using a seed keyword that consists of multiple terms {a₁, a₂, . . . aₙ} as shown in FIG. 3 block 100. Seed Keyword Analysis block 110 verifies a keyword's main parameters (possible misspellings, language of use, etc.) and generates a request sequence 120 to generate a SKC. Keyword Meanings Generator block 130 consists of four blocks and works as follows: it first collects appropriate documents by Document Collection block 131, than it extracts the most popular keywords from these documents in Keyword Extraction block 132, normalizes, ranks and orders such keywords in Keyword Normalization block 133, and generates meanings and meanings' proximity scores in Meanings Generation and Score Computation block 134. The resulting SKC and meanings proximity scores 140 are used as input to the Truncation and Presentation Block 150 that truncates the SKC based on performance or other requirements and outputs the final SKC and proximity scores 160.

### Additional Embodiments

In one embodiment of the invention related to FIG. 4 the Data Collection block 131 is collecting keyword source documents by Internet crawling.

In one embodiment of the invention related to FIG. 4 the Data Collection block 131 is collecting keyword source documents by sending sequences of keywords to one or more Search Engines and collecting pages with search engine matches.

In one embodiment of the invention related to FIG. 4 the Data Collection block 131 is collecting keyword source documents by sending sequences of keywords to one or more Search Engines and one or more encyclopedia and Blog sites and collecting pages with search engine matches.

In one embodiment of invention related to FIG. 4 seed keyword 100 is replaced with another keyword 120 using a pre-defined algorithm or by human interaction implemented in Seed Keyword Analysis block 110.

In one embodiment of the invention presented by FIG. 5 a seed keyword 200 is replaced in the Seed Keyword Filtering block 210 by a set of seed keywords 220 each of which have varying weight coefficients. Later each keyword is separately processed in Seed Keyword Analysis block 230 to generate keywords and their parameters 240. Keywords and their parameters 240 are input in the Keyword Meaning Generator block 250 that consists of four blocks and works as follows: it first collects appropriate documents by Document Collection block 251, than it extracts the most popular keywords from these documents in Keyword Extraction block 252, normalizes, ranks and orders such keywords in Keyword Normalization block 253, and generates meanings and meanings' proximity scores in Meanings Generation and Score Computation block 254. The resulting SKC and meanings proximity scores 260 are used as input to the Meanings Aggregation block 270 that uses existing weight coefficients as aggregation parameters. The output of block 270 is a SKC and SKC meaning's proximity scores 280. The SKC 280 is an input into the Truncation and Presentation Block 290 that truncates a SKC based on performance or other requirements and outputs a final truncated SKC 295.

In one embodiment of the invention SKC and meanings proximity scores are generated using statistical analysis algorithms.

In one embodiment of the invention SKC and meaning proximity scores are generated using human interactions.

In one embodiment of the invention the method and apparatus finds for a chosen seed keyword one or more different seed keywords (called “backlink” or “reverse keywords”) that use such chosen seed keyword as their meaning in their relevant SKCs. For a backlink keyword it computes a backlink proximity score for the chosen keyword and aggregates backlink keywords into the chosen seed keyword's SKC as a special backlink meaning.

In one embodiment of the invention SKC size in Truncation and Presentation blocks 150 and 290 can be defined dynamically based on relative proximity scores.

In one embodiment of the invention SKC size in Truncation and Presentation blocks 150 and 290 can be defined statically and changed interactively based on SKC size criteria.

In one embodiment of the invention the SKC of a seed keyword can be extended by aggregation with at least one of the following: (i) a SKC of the seed keyword's neighbor, (ii) a SKC of the seed keyword's neighbor's neighbor, (iii) a SKC of the seed keyword's neighbor's neighbor's neighbor etc. up to arbitrary level of indirection. The above extension is called extension by transitive closure of the keyword-neighbor (meaning) relationship.

In one embodiment of the invention the SKC of a seed keyword can be extended by transitive closure of the neighbor-keyword relationship where neighbor-keyword relationship is defined as the inverse relationship to the keyword-neighbor relationship.

Although the above description contains much specificity, the embodiments described above should not be construed as limiting the scope of the invention but rather as merely illustrations of some presently preferred embodiments of this invention.

1. A method of semantic keyword cluster generation, comprising:
(i) a set of seed keywords,
(ii) crawling the internet and collecting a set of internet pages,
(iii) extracting a set of representative keywords from said set of internet pages,
(iv) computing a set of neighbor keywords from said set of representative keywords,
(v) computing a set of scores corresponding to said set of neighbor keywords.

2. Method of claim 1 wherein said set of internet pages is collected by sending said set of seed keywords to one or more search engines, collecting pages with matches from said search engines, extracting a set of representative keywords from said pages, computing said set of neighbor keywords from said set of representative keywords, and computing said sets of scores for said set of neighbor keywords.

3. The method of claim 1 wherein said set of internet pages is collected by sending said set of seed keywords to one or more search engines and one or more encyclopedia sites, collecting pages with matches from said search engines and said encyclopedia sites, extracting said set of representative keywords from said pages, computing said set neighbor keywords from said set of representative keywords, and computing said sets of scores for said set of neighbor keywords.

4. The method of claim 1 wherein said set of seed keyword is replaced with a new set of seed keywords computed by a pre-defined algorithm and a set of human interactions.

5. The method of claim 1 wherein said set of seed keywords is replaced by a new set of seed keywords accompanied by a set of weight coefficients, wherein for each keyword in the said new set of seed keywords a semantic keyword cluster is generated and said semantic keyword clusters are aggregated into a final semantic keyword cluster.

6. The method of claim 5 wherein said new set of seed keywords is generated by replacing a word in a keyword in said set of seed keywords with said word's plural or singular form.

7. The method of claim 5 wherein said new set of seed keywords is generated by replacing an existing word in said set of seed keywords by a new word generated by a stemming procedure on the said existing word.

8. The method of claim 5 wherein said new set of seed keywords is generated by replacing an existing word in said set of seed keywords with said existing word's synonyms.

9. The method of claim 5 wherein said new set of seed keywords is generated by combining permutations of words in keywords from said existing set of seed keywords.

10. The method of claim 5 wherein said new set of seed keywords is generated by combining subsets of words of keywords from said existing set of seed keywords.

11. The method of claim 1 wherein said set of neighbor keywords is enhanced by adding backlink keywords with highest reverse scores resulting from computing new sets of neighbor keywords for each neighbor in said set of neighbor keywords and aggregating the said new set of neighbor keywords' scores.

12. The method of claim 1 wherein said set of neighbor keywords is enhanced by adding new keywords by computing new sets of neighbor keywords for each neighbor in said set of neighbor keywords.

13. An apparatus, comprising:
A keyword creation pipeline, and an internet crawling means for said keyword creation pipeline, and an internet page collecting means for said keyword creation pipeline, and a representative keyword extracting means for said keyword creation pipeline, and a neighbor extracting means for said for said keyword creation pipeline, and a score computing means for said keyword creation pipeline.

14. The apparatus of claim 13 wherein said keyword creation pipeline includes a keyword stemming device.

15. The apparatus of claim 13 wherein said keyword creation pipeline includes a word permutation device.

16. The apparatus of claim 13 wherein said keyword creation pipeline includes an aggregation and averaging device.

17. The apparatus of claim 13 wherein said keyword creation pipeline includes a backlink generation and computation device.

18. The apparatus of claim 13 wherein said keyword creation pipeline includes a transitive neighbor generation device.
